(19) United States
(12) Patent Application Publication
(10) Pub. No.: US 2009/0125508 A1
(43) Pub. Date: May 14, 2009

(54) SYSTEMS AND METHODS FOR FILE TRANSFER TO A PERVASIVE COMPUTING SYSTEM

(75) Inventors: Anthony Eugene Collins, Balmain (AU); Judith Kay, Dover Heights (AU)

Correspondence Address: KNOBBE MARTENS OLSON & BEAR LLP, 2040 MAIN STREET, FOURTEENTH FLOOR, IRVINE, CA, 92614, US

(73) Assignee: Smart Internet Technology CRC Pty Ltd., Eveleigh (AU)

(21) Appl. No.: 12/264,031

(22) Filed: Nov. 3, 2008

Related U.S. Application Data
(60) Provisional application No. 60/984,877, filed on Nov. 2, 2007.

(30) Foreign Application Priority Data
Nov. 2, 2007 (AU) 2007231829

(51) Int. Cl. G06F 7/06; G06F 17/30

(52) U.S. Cl. 707/5; 707/E17.014

(57) ABSTRACT

Embodiments of the invention described herein provides a system and method for transferring files in a pervasive computing system. The methods comprises the steps of selecting at least a sub-set of files to be made available to a remote computing system and determining a relevance score for each of the sub-set of files to a remote computing system. Information regarding the relevance of each of the files in the sub-set of files is made available with the file.

### CROSS-REFERENCE TO RELATED APPLICATIONS

This application claims the benefit of U.S. Provisional Application No. 60/984,877, filed Nov. 2, 2007, and Australian Patent Application No. 2007231829, filed Nov. 2, 2007, both of which are incorporated herein by reference in their entirety.

### BACKGROUND

1. Field

The present invention relates to systems and methods for transferring electronic files between two or more computing devices and more particularly, but not exclusively, to systems and methods for transferring multimedia files to a pervasive computing system.

2. Description of the Related Technology

Interactive desktop interfaces are known as part of current computer operating systems. In some computing applications it is desirable to have an interactive tabletop interface. An interactive tabletop interface allows for interaction with one or more users on a real tabletop, rather than a (virtual) desktop. An interactive tabletop interface facilitates collaborative sharing of objects such as digital photographs by a number of users. Such an interface comprises a displayed image which is projected onto a tabletop. The image is displayed, for example, by use of a data projector, which projects the image onto the tabletop. One or more users can interact with the displayed image via an input of the interface, in order to, for example, manipulate objects in the displayed image. Input to the interface is provided by, for example, a touch sensitive surface, of the tabletop onto which the image is projected. This type of computer interface facilitates so-called “pervasive” computing.

### SUMMARY

In a first aspect, the present invention provides a method for transferring files in a pervasive computing system, comprising the steps of:

selecting at least a sub-set of files to be made available to a remote computing system,

determining a relevance for each of the sub-set of files to a remote computing system,

wherein information regarding the relevance of each of the files in the sub-set of files is made available with the file.

The method may comprise the further step of determining the relevance of each of the sub-set of files by adjusting at least one parameter relevant to a characteristic of the sub-set of files.

The characteristic may be meta-data associated with each of the sub-set of files. The meta-data may be contained in the header portion of the file.

The relevance of a sub-set of files may be utilised to rank each of the sub-set of files to a focus file.

On the user selecting a different focus file, the method may comprise the further step of recalculating the relevance of each of the sub-set of files when compared to the focus file.

The step of ranking the relevance of each of the subset of files may be determined utilising the formula:

$$r = [ \frac{ω}{t} \times 100 ]$$

where r is the rank, w is the relevance score for each of the characteristics of one of the sub-set of files, and t is the total relevance score achievable for the file.

The characteristics may include at least one of the authors of the file, the name of the file, a text comment associated with the file, a creation date of the file, a modification date of the file, a file system path of the file, an e-mail address associated with the file, and a display name associated with the file.

A representation of each one of the sub-set of files may be displayed on a computing interface. Moreover, a representation of the relevance of each file is also displayed on the computing interface. The representation of the relevance of each of the sub-set of files may be the size of the representation. As the relevance of the each file is increased, the size of the representation may also be increased.

In a second aspect, the present invention provides a system for transferring files comprising

a module arranged to select at least a sub-set of files to be made available to a remote computing system,

a determination module arranged to determine a relevance score for each of the sub-set of files to a remote computing system,

wherein information regarding the relevance of each of the files in the sub-set of files is made available with the file.

In a third aspect, the present invention provides a computer program comprising at least one instruction which, when implemented on a computer readable medium of a computer system, causes the computer system to implement the method in accordance with the first aspect of the invention.

In a fourth aspect, the present invention provides a computer readable medium providing a computer program in accordance with the third aspect of the invention.

In the context of the specification, the term “file” is intended to be construed broadly and include within its scope any block of arbitrary data that is utilisable by a computing system. Files may, for example, include multimedia files (e.g. audio files, video files, data files, etc.) or other information blocks, such as emails, instant messages, or any other self contained “piece” of data. Moreover, the files may be encoded or encrypted as required.

### BRIEF DESCRIPTION OF THE DRAWINGS

Features and advantages of the present invention will become apparent from the following description of embodiments thereof, by way of example only, with reference to the accompanying drawings, in which:

FIGS. 1a and 1b are diagrams of a system for transferring files between computing devices, in accordance with an embodiment of the present invention;

FIG. 2 is a chart illustrating a series of classes that constitute a software application in accordance with an embodiment of the present invention; and

FIG. 3 is a flowchart illustrating the method steps performed by an embodiment of the present invention;

FIGS. 4 to 7 are screen shots of user interface components for setting manipulable parameters for transferring files to a remote computing system in accordance with an embodiment of the present invention.

### DETAILED DESCRIPTION OF EMBODIMENTS

In the description which follows an embodiment of the present invention is described in the context of a system and method for transferring multimedia files, such as compressed video and image files, between two computers remotely connected over a communications network in the form of Local Area Network (LAN). However, it should be understood that the present invention is not limited to the example application described herein and is equally applicable for transferring any form of electronic file between any number and configuration of computing systems.

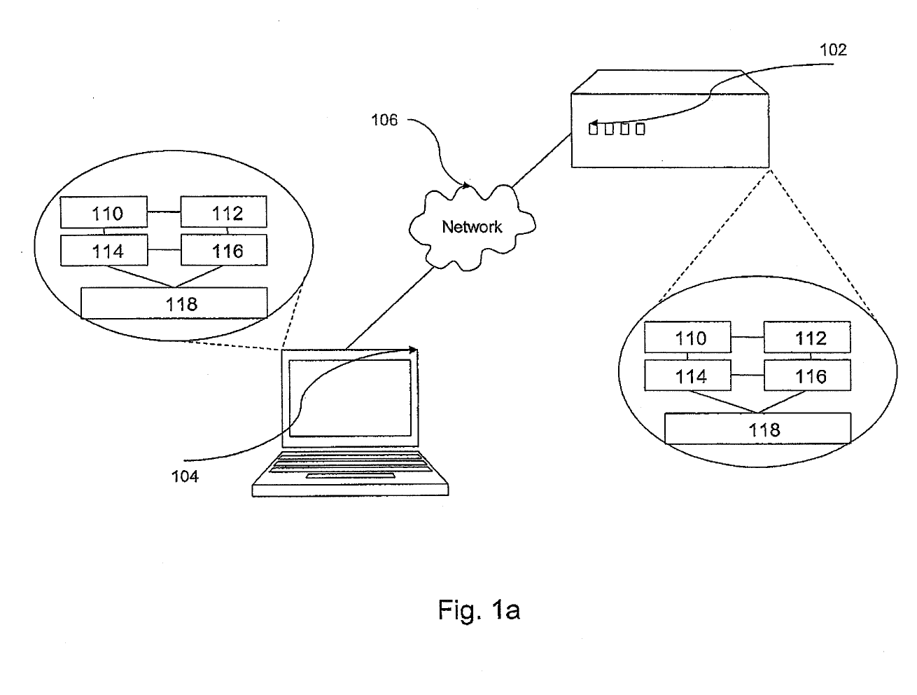

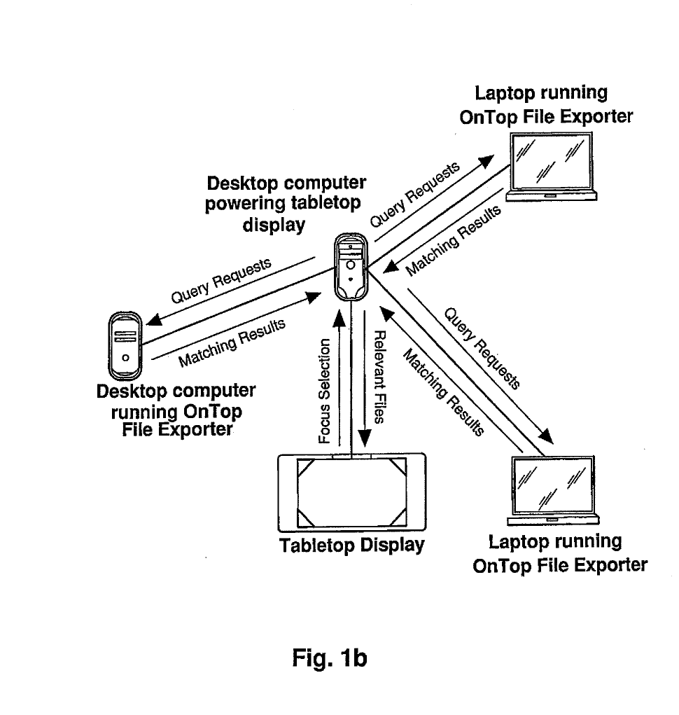

With reference to FIGS. 1a and 1b, multimedia files are transferred between two computing devices in the form of a personal computer including a surface-mount touch screen display (hereafter “tabletop computer”) and a laptop or other remote computer 102, 104, respectively. In the embodiment described herein, the laptop computer 104 serves as the “host” computer providing the multimedia files for transfer, while the tabletop computer serves as the “client” computer configured to receive the files.

The computers 102, 104 are connected over a communications network in the form of a LAN 106 and communicate using a packet-switched protocol, such as the TCP/IP protocol. The tabletop computer 102 includes a user interface provided on the surface-mount display. The user interface is a graphical user interface (GUI) arranged to display multimedia files stored by the tabletop computer 102 and receive commands for manipulating the files and objects/icons associated therewith.

To carry out this functionality, the tabletop computer 102 comprises computer hardware including a motherboard, central processing unit 110, random access memory 112, hard disk 114 and networking hardware 116. In addition to the hardware, the tabletop computer 102 includes an operating system (such as the Linux operating system, which can be obtained from the Internet from a number of providers, such as but not limited to websites located at URLs http://www.redhat.com, http://www.suse.com and http://www.ubuntu.com) that resides on the hard disk and which co-operates with the hardware to provide an environment in which the software applications can be executed.

The tabletop computer 102 also includes a receiving module including standard software and hardware (such as a TCP/IP socket) for receiving multimedia files sent from the laptop computer 104.

The second computing device 104 is in the form of laptop computer 104. The laptop computer 104 comprises essentially the same hardware as the tabletop computer 102 (i.e. motherboard, central processing unit, random access memory, a hard disk or other similar storage device, monitor and a user input). In addition, the hard disk of the laptop computer 104 is loaded with an operating system (such as Microsoft Windows XP™, available from Microsoft Corporation or Apple OS X™, available from Apple Inc.) capable of interacting with the hardware of the laptop computer 104 to provide an environment in which software applications can be executed.

Referring to FIG. 1b in particular, there is shown a system diagram illustrating the components of a system in accordance with an embodiment of the present invention. The system includes a tabletop computing system 102 which is made up of a tabletop display 102a and a computing system 102b (collectively 102), and one or more computing devices 104a, 104b, 104c (collectively 104) in communication with the tabletop computing system 102.

The tabletop computing system includes a software application which is hereinafter referred to as “OnTop”. OnTop is implemented as a plug-in module to an image sharing application dubbed “Cruiser”. However, it will be understood that the OnTop software application may also be implemented as a stand-alone application, as required.

The OnTop plug-in provides a range of functions which are arranged to allow a user of the tabletop computing system 102 to interact with files that reside on the laptop computers 104. These functions, broadly defined, include:

network co-ordination between OnTop and all instances of the OnTop File Exporter on the network;

the ability to dwell on a file to select it as a focus item, resulting in the tabletop being cleared of irrelevant files when new results are received from remote file systems;

animation of relevant files as they are loaded onto the tabletop;

persistent positioning of files on the tabletop;

the History Browser to show past focus files and allow users to return to a previous focus;

flipping files over to see their filename; and

sizing files according to their calculated relevance to a focus file.

In other words, FIG. 1b depicts an example OnTop environment. The environment is comprised of multiple computers, such as laptops and desktop computers that export their file system to OnTop. The computer running OnTop (and powering the tabletop display) connects to each of these computers, and performs query requests whenever a focus file is selected on the tabletop by a user.

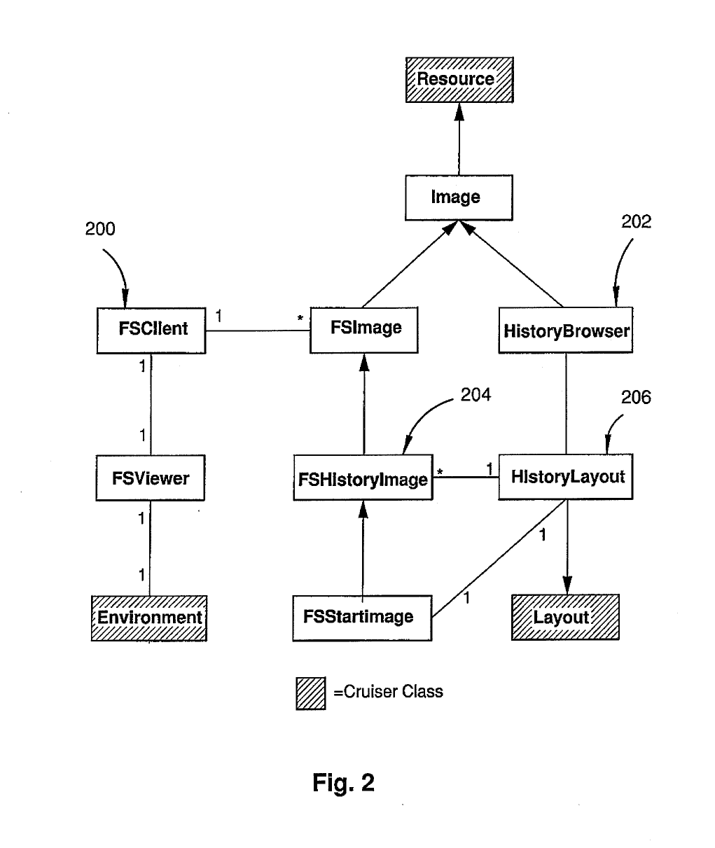

A UML class diagram showing the structure of the OnTop plug-in is shown in FIG. 2. Classes with a ‘greyed’ background are core classes in the existing Cruiser application.

The OnTop plug-in subclasses, in combination, implement the specific functionality of the On-top application (as listed above). The files displayed on the tabletop computing system are managed by an instance of the FSClient class 200, and the files are represented by instances of the FSImage class. The HistoryBrowser class 202 is used to implement the History Browser, and FSHistoryImages 204 are thumbnail representations of past focus files. The HistoryLayout 206 class is responsible for organising the History Browser 208 thumbnails.

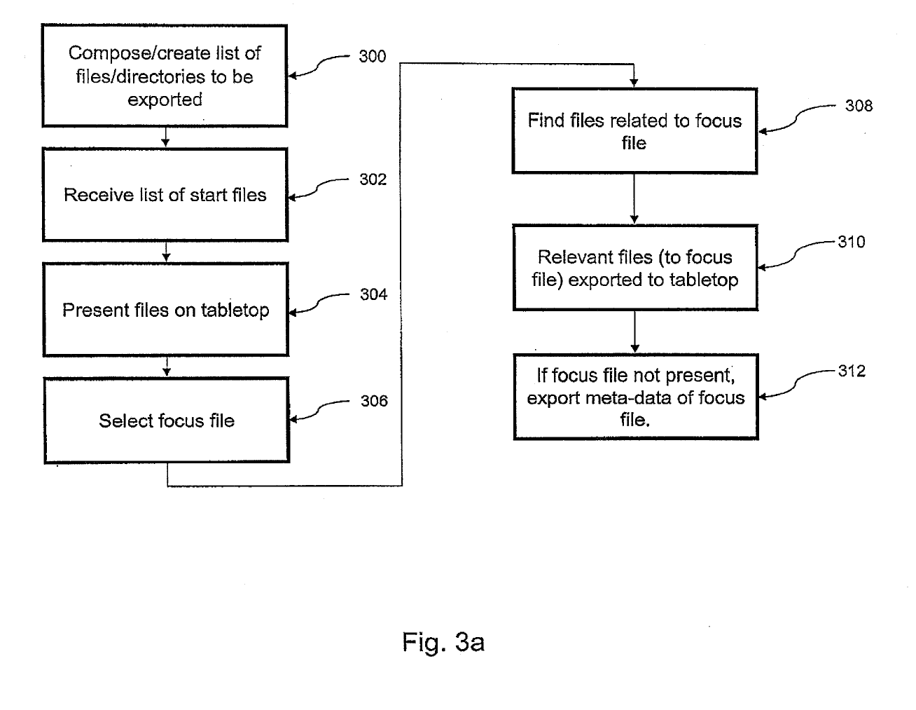

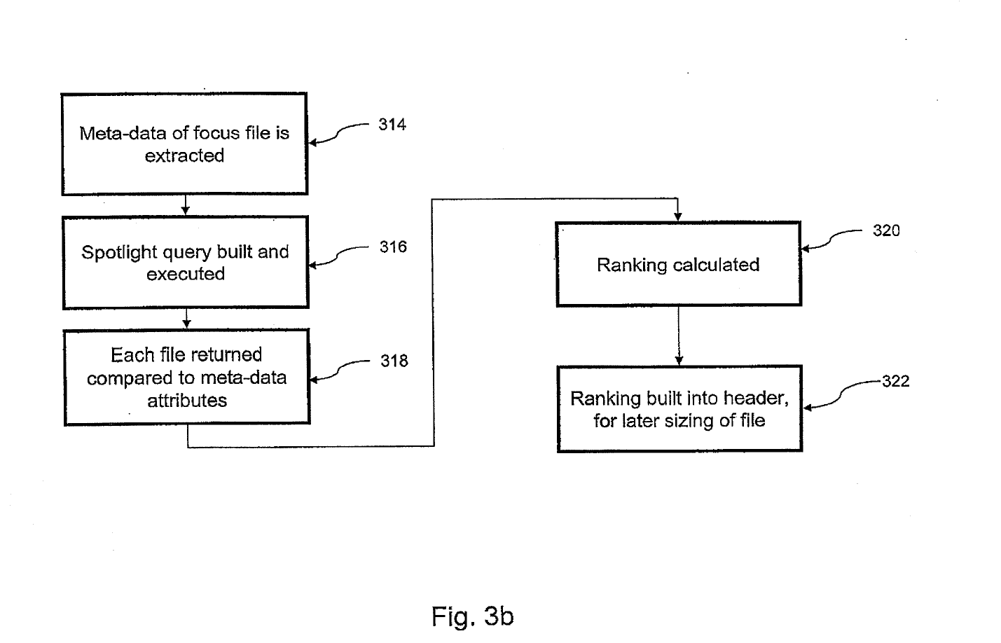

An overview of the OnTop system will now be provided with reference to FIGS. 3a and 3b. FIG. 3a depicts the method steps carried out when a tabletop interacts with remote computing systems, such as laptops, desktop computers, etc. The list of file systems to connect to from the table is set in a configuration file before launching OnTop (step 300). When OnTop is launched, a connection is made to each OnTop File Exporter instance, and a request is sent to retrieve the list of start files (based on the user-defined starting view) (step 302). The OnTop interface then presents the start files from each file system on the tabletop (step 304). Users are then free to interact with the system, and select desired focus items.

A focus item is an item which appears when a user first accesses their files via the tabletop computing system. As implied by the name, a focus item is a primary item to which other items are associated.

When a focus item is selected (step 306), a request to find related files is sent to each OnTop File Exporter instance (step 308). If a request is sent to the computer containing the selected focus file, then OnTop requests that files relevant to the focus item be transferred to the tabletop computing system (step 310). If the request is sent to a File Exporter instance that does not contain the selected focus file, then the meta-data of the focus file is sent to the File Exporter instance instead (step 312).

Each relevant file returned to OnTop by a File Exporter instance is prefixed with a header.

The header consists of a ‘map’ containing meta-data attributes and their values, followed by an integer relevance (within the range 1 . . . 100). The meta-data attributes are stored in OnTop so that when a focus selection is made, files relevant to the focus can be requested from file systems that do not contain the original focus file.

The relevance is used to set the scale of the file's graphical representation on the tabletop. When a new result is displayed to the tabletop, it is first checked whether the file has a cached position. If a cached position exists, the cached position is used in order to make the positioning of files on the tabletop persistent.

The OnTop File Exporter is a light-weight application that accepts connections from permitted tabletops and responds to query requests. The querying functionality of the Exporter is based on the Spotlight framework (see for example, Apple Computer, “Working with Spotlight”, located at URL http://developer.apple.com/macosx/spotlight.html).

The File Exporter is written in Objective-C using the Apple OS X Cocoa frameworks.

The working of the File Exporter is now described with reference to the flow chart of FIG. 3b. To find files related to a focus, the meta-data of the focus is extracted (step 314) and used to build a Spotlight query (step 316). For example, the title, keywords, and authors of a file are extracted and a query is formed that matches the values against the full text content and meta-data of every document contained in the user-defined areas of the file system that should be exported.

The use of this existing search framework allows OnTop to provide a powerful and flexible associative-search system.

### Ranking

After a query has been conducted and a list of matching results has been returned by Spotlight, each result is compared with the current focus file according to the weightings given to each of the meta-data attributes (step 318).

For each meta-data field mᵢ of a result, the value of the same meta-data field of the focus item fmᵢ is compared with the value of mᵢ; that is, value (mᵢ) is compared with value(fmᵢ). If a match is made in the comparison, then a weighting, weight (fmᵢ), is added to a total weighting for the result, w. The weight of each meta-data attribute of the result that can be compared with a value in the focus items' meta-data is added to a total, t. If the mᵢ meta-data field is not present in the focus item, then a weighting of zero will be returned because a comparison cannot be made.

However, an exception to this is cross-attribute comparisons, which occur between filenames, keywords, and comments assigned to files.

Once all meta-data attributes present in the result and focus file have been compared, the ranking of a result, r, is defined (step 320) by:

$$r = [ \frac{ω}{t} \times 100 ]$$

The ranking, r, is then returned to the OnTop client contained in a header describing the result (step 322). The header contains all meta-data associated with the file, so that OnTop can later request related files from other file systems that do not contain the focus file.

### Meta-Data

Each meta-data field is compared in a slightly different way, depending on its type and meaning.

Table 1 gives a description of how comparisons are made for each meta-data attribute. The Spotlight framework provides an extensive list of meta-data attributes to be used when searching for files. However, a subset of the attributes are used in the OnTop system. The attributes chosen allow flexibility in the way that relevance is calculated, while still retaining simplicity so that non-technical users can easily understand their meaning.
OnTop and computers running the OnTop File Exporter communicate using an efficient text-based protocol over a TCP socket.

The OnTop File Exporter advertises its presence on the network using the Bonjour/Zeroconf service discovery framework (Apple Computer, Bonjour, located at URL http://developer.apple.com/networking/bonjour/).

TABLE 1
A list of attributes utilised to calculate the relevance
of a file to a focus file.

| Attribute Name | Comparison Type |
|---|---|
| Item Display Name | A case insensitive word-based comparison. |
| | Words must be longer than 2 characters to be |
| | compared. |
| Item Keywords | A case insensitive word-based comparison. There |
| | is no minimum keyword length. |
| Item Finder Comment | Finder Comments are interpreted as keywords, |
| | and are compared with a case insensitive word- |
| | based comparison. There is no minimum |
| | comment length. |
| Item Content Creation | Items created within 24 hours of each other are |
| Date | considered a successful match. |
| Item Path | Items in the same path are considered a successful |
| | match. The path must be exactly the same; both |
| | items must be in the same directory. |
| Item Authors | A full-name, case insensitive, author-based |
| | comparison. Names must be matched exactly. |
| Item E-mail Addresses | A case insensitive address based comparison. |
| | Addresses must be matched exactly. |
| Item Where From | An address-based comparison (for URLs). URLs |
| | must be matched exactly. |
| Item Album | A case sensitive comparison. The exact album |
| | name must be matched. |

Files are not contained on the computer that powers the tabletop display. Rather, the system is designed to query and retrieve data from multiple remote file systems.

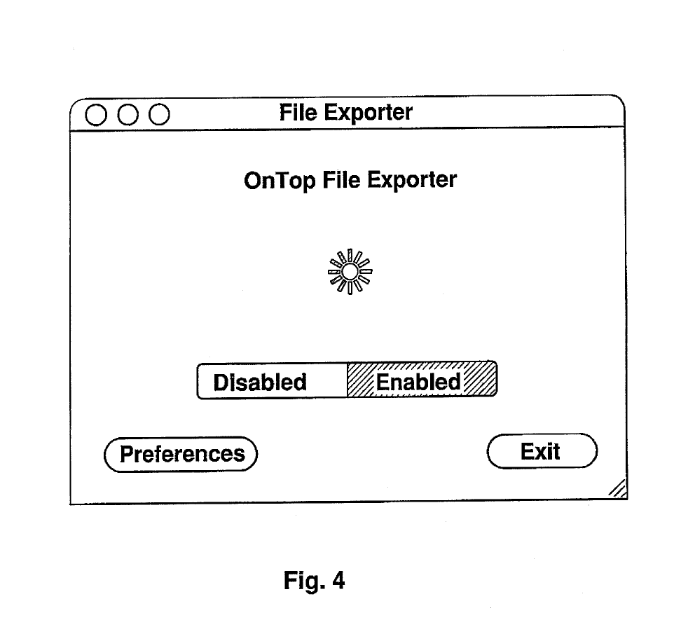

The OnTop File Exporter application, which also uses a progress indicator to indicate if there are active queries. The OnTop File Exporter allows users to export their file system to multiple tabletop displays over a Local Area Network (LAN). A tabletop display will be able to connect to the machine running the File Exporter application, perform queries for relevant files throughout the file system, calculate the relevance of each result to the current focus item on the tabletop, and retrieve image representations of each result for presentation to the user. The File Exporter interface also indicates when there are queries currently being processed on the computer, as shown in FIG. 4.

The following description outlines the configuration and personalisation options available to users of the File Exporter.

Users are given complete control over which areas of their file system may be accessed by a tabletop, and which tabletop displays may connect to the computer and access the information. This feature ensures privacy.

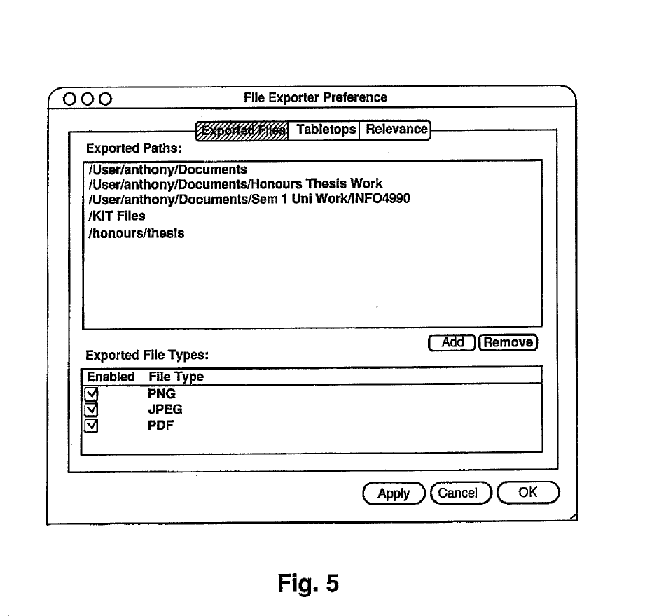

The Exported Files tab of the user preferences panel, shown in FIG. 5, allows users to set a list of locations in the file system that may be accessed by tabletops. Each exported path will also export any sub-directories, or an individual file may be exported instead. For example, in FIG. 5, the Exported Paths settings will enabled five directories to be accessed by tabletops.

Users may also select which types of files may be accessed by tabletops from a list of supported types. This list currently includes common image types such as JPEG, and PDF documents. Other types of documents, such as e-mail, can be exported by simply converting them to either an image or PDF document.

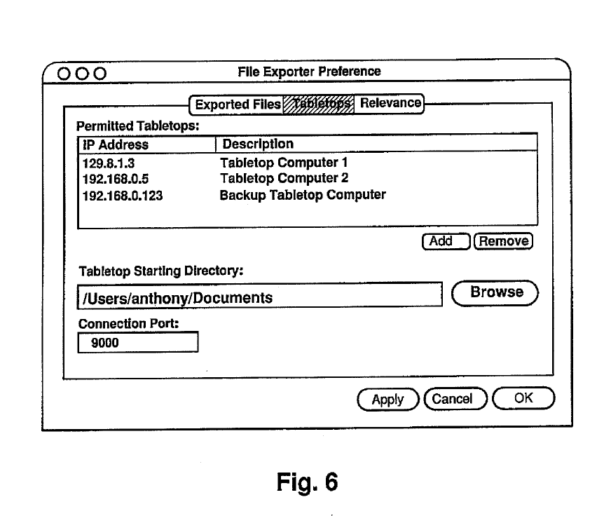

Users may configure a tabletop access list, shown in FIG. 6, where only tabletops contained in the list will be able to connect to the computer. The authentication is Internet Protocol (IP) address-based although it will be understood that any suitable communications or data/file transfer protocol may be utilised, as required by a particular application.

Users may also set the starting view of the file system, and also the TCP connection port that tabletops should connect to. For example, based on the settings in FIG. 6, three tabletops will be allowed to connect to the computer and request files, and the starting view in OnTop will present the first file of a supported type in each sub-directory of the user's ‘Documents’ directory.

### Relevance Calculation

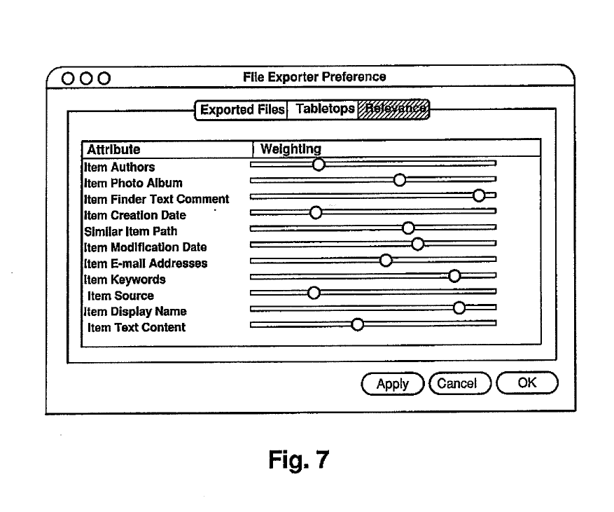

Given the unique and personal nature of file system organisation and content, the OnTop File Exporter enables users to customise how their files are determined relevant to a given focus, by selecting on a scale of 1 to 10 how important certain attributes are to the organisation of their information. These settings are shown in FIG. 7.

Referring to FIG. 7, if files created by the same author were often highly relevant to each other in a user's file system, the weighting can be increased using the slider to influence the relevance calculation mechanism. Users may alter the weightings at any time, including when a tabletop is already connected to the computer and performing queries. In other words, settings can be easily adjusted when different collections of documents are exported. For example, meta-data may have different semantics for different collections of files, so the relevance calculation settings could be adjusted on a per-use basis (depending on which collection of files is being exported).

The meta-data weightings available for customisation are listed in Table 2, along with a description of their intended usage. The core metadata weightings that are initially enabled by default with a value of seven (7) are:

Item Keywords;

Item Path;

Item Display Name; and

Item Text Content.

TABLE 2
Meta-data weightings available for customisation

| Attribute Name | Description of Usage |
|---|---|
| Item Authors | Indicates items by the same author(s) are |
| | relevant to each other. |
| Item Photo Album | Indicates items contained in the same |
| | photo album are relevant to each other. |
| Item Finder Text Comment | Indicates items with a similar comment are |
| | relevant to each other. |
| Item Creation Date | Indicates items with a similar creation date |
| | are relevant to each other. |
| Item Modification Date | Indicates items with a similar modification |
| | date are relevant to each other. |
| Item Path | Indicates items stored in the same |
| | directory are relevant to each other. |
| Item E-mail Addresses | Indicates items associated with the same e- |
| | mail addresses are relevant to each other. |
| Item Keywords | Indicates items with similar keywords are |
| | relevant to each other. |
| Item Source | Indicates items obtained from the same |
| | source (such as a web site) are relevant to |
| | each other |
| Item Display Name | Indicates items with the same display |
| | name are relevant to each other |
| Item Text Content | Indicates items with meta-data that is |
| | similar to the text content of an item are |
| | relevant to each other. |

OnTop is designed to connect to multiple machines (typically on the same LAN) to request queries and accept results relevant to a specific focus file. The advantage of this is that OnTop is able to transparently merge relevant information from multiple file systems.

### Advantages

To highlight how embodiments of the invention are useful in a real-world context, the following scenario is presented:

A group of four university students is organising an upcoming social dinner for first year computer science students to attend. Each of the students has been assigned a piece of work related to either the event organisation, ticket sales, or advertising.

Fred has been using an Excel spreadsheet to manage ticket and seat allocation, while Alice has been organising the venue booking using an e-mail client to communicate with the venue manager. John has been designing an advertisement flyer using a Photoshop document, and Steve has been building a website to allow students to easily book tickets and decide where they want to sit. Each of the four tasks are highly interrelated, as they rely on information that other students are working on.

Furthermore, a change in one of the event organisation areas (such as the venue location or date), needs to be communicated to all other group members. Currently, each group member uses e-mail to send their work to all other members after every significant change.

This results in many copies of work being sent around in the group, where each member must manually manage each of the versions. In addition, when the group regularly meets each week with their laptops to exchange and discuss new information, they must e-mail their work to each of the members, and attempt to combine the event information from many different sources and document types, as well as integrate any new versions into their existing collection of the group work. As the group discusses each piece of work, all members must find and switch between each file, wherever they have stored it in their file system. The group would like to use a tabletop display to collaborate over the project information, but they must merge and copy this information onto the computer that powers the tabletop display first.

It can be seen from this scenario that each group member has a set of personal files that they would like to share at the tabletop. It would be cumbersome to manually copy each of the required files to a single machine that powers the tabletop display every time the group wants to use the tabletop for collaboration. For this reason, the group could significantly benefit from being able to simply export their files to the table directly from their laptop computers without needing to explicitly transfer files between devices. OnTop transparently transfers files between devices only when needed, and provides a view of these files that highlights related content from multiple heterogeneous file systems.

This design is highly aligned with goals of Ubiquitous Computing, where the tabletop is integrated in the environment, and it is not thought of as a traditional computer, as the goal of many tabletop computing devices is to ensure that the underlying computation is completely invisible to users.

OnTop is a multi-user interface that transparently merges multiple remote file systems for interaction on a tabletop. This means that when interacting with OnTop, the interface presents what appears to be a single file-space.

As users navigate by selecting focus items, relevant files from remote file systems will be displayed in the interface. This means that users do not need to know which computer files are stored on, or where in the file system hierarchy they are located. This is clearly beneficial for group collaboration, as each member of the group is able to share files from their own file system with minimum effort.

This feature is also useful as a tool for information discovery, because it finds relevant information from multiple sources. For example, when working on a project, a group member may have documents in their file system related to the project that they have forgotten about. This forgotten information will be displayed prominently when a file highly related to it is selected as a focus.

The starting view of a file system (described above) is configured on each remote file system, so that the files in the starting view of each remote file system will be displayed together when no focus file is selected.

The OnTop system has been described with reference to the transfer/storage of common image types and PDF documents. However, other document types can easily be included in the system. That is, the OnTop File Exporter can be extended to work with additional file types. Such changes/alterations are within the purview of a person skilled in the art.

Moreover, it will be understood that software applications may be implemented as a combination of routines, libraries, procedures, macros, code segments, etc., either contained within one file or across multiple files, and may be stored on a single physical device or spread across a number of physical storage devices, computing systems and/or electronic devices. The present invention may therefore be implemented in any number of ways without departing from the spirit and scope of the invention described and claimed herein.

What is claimed is:

1. A method for transferring files in a pervasive computing system, comprising the steps of:
selecting at least a sub-set of files to be made available to a remote computing system,
determining a relevance score for each of the sub-set of files to a remote computing system,
wherein information regarding the relevance of each of the files in the sub-set of files is made available with the file.

2. A method in accordance with claim 1, comprising the further step of determining the relevance of each of the sub-set of files by adjusting at least one parameter relevant to a characteristic of the sub-set of files.

3. A method in accordance with claim 2, wherein the characteristic is meta-data associated with each of the sub-set of files.

4. A method in accordance with claim 3, wherein the relevance of a sub-set of files is utilised to rank each of the sub-set of files to a focus file.

5. A method in accordance with claim 4, wherein, on the user selecting a different focus file, the method comprises the further step of recalculating the relevance of each of the sub-set of files when compared to the focus file.

6. A method in accordance with claim 4, wherein the step of ranking the relevance of each of the subset of files is determined utilising the formula:
$$r = [ \frac{ω}{t} \times 100 ]$$
wherein r is the rank, w is the relevance score for each of the characteristics of one of the sub-set of files, and t is the total relevance score achievable for the file.

7. A method in accordance with claim 2, wherein the characteristics include at least one of the authors of the file, the name of the file, a text comment associated with the file, a creation date of the file, a modification date of the file, a file system path of the file, an e-mail address associated with the file, the textual content of the file, and a display name associated with the file.

8. A method in accordance with claim 3, wherein the meta-data is contained in the header portion of the file.

9. A method in accordance with claim 1, wherein a representation of each one of the sub-set of files is displayed on a computing interface.

10. A method in accordance with claim 9, wherein a representation of the relevance of each file is also displayed on the computing interface.

11. A method in accordance with claim 10, wherein the representation of the relevance of each of the sub-set of files is the size of the representation.

12. A method in accordance with claim 11, wherein, as the relevance of the each file is increased, the size of the representation is increased.

13. A system for transferring files comprising:
a module arranged to select at least a sub-set of files to be made available to a remote computing system,
a determination module arranged to determine a relevance score for each of the sub-set of files to a remote computing system,
wherein information regarding the relevance of each of the files in the sub-set of files is made available with the file.

14. A system in accordance with claim 13, wherein the relevance of each of the sub-set of files is determined by adjusting at least one parameter relevant to a characteristic of the sub-set of files.

15. A system in accordance with claim 14, wherein the characteristic is meta-data associated with each of the sub-set of files.

16. A system in accordance with claim 15, wherein the relevance of a sub-set of files is utilised to rank each of the sub-set of files to a focus file.

17. A system in accordance with claim 16, wherein, on the user selecting a different focus file, wherein the relevance of each of the sub-set of files is recalculated when compared to the focus file.

18. A system in accordance with claim 16, wherein ranking the relevance of each of the subset of files is determined utilising the formula:
$$r = [ \frac{ω}{t} \times 100 ]$$
wherein r is the rank, w is the relevance score for each of the characteristics of one of the sub-set of files, and t is the total relevance score achievable for the file.

19. A system in accordance with claim 14, wherein the characteristics include at least one of the authors of the file, the name of the file, a text comment associated with the file, a creation date of the file, a modification date of the file, a file system path of the file, an e-mail address associated with the file, the textual content of the file, and a display name associated with the file.

20. A system in accordance with claims 15, wherein the meta-data is contained in the header portion of the file.

21. A system in accordance with claim 14, wherein a representation of each one of the sub-set of files is displayed on a computing interface.

22. A system in accordance with claim 21, wherein a representation of the relevance of each file is also displayed on the computing interface.

23. A system in accordance with claim 22, wherein the representation of the relevance of each of the sub-set of files is the size of the representation.

24. A system in accordance with claim 23, wherein, as the relevance of the each file is increased, the size of the representation is increased.

25. A computer program comprising at least one instruction which, when implemented on a computing system, causes the computing system to implement the method in accordance with claim 1.

26. A computer readable medium providing a computer program in accordance with claim 25.
